(19) United States
(12) Patent Application Publication
(10) Pub. No.: US 2007/0052980 A1
(43) Pub. Date: Mar. 8, 2007

(54) Image forming apparatus and copy restriction method thereof

(75) Inventor: Jae-in Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/487,371

(22) Filed: Jul. 17, 2006

(30) Foreign Application Priority Data
Sep. 2, 2005 (KR) 10-2005-0081745

(51) Int. Cl. G06F 3/12

(52) U.S. Cl. 358/1.1; 358/1.15

(57) ABSTRACT

An image forming apparatus and a copy restriction method thereof are provided, wherein the image forming apparatus includes a reader for receiving an output with a copy restriction mark including the number of possible copies, a printing part for printing the output which is input through the reader or provided from a user terminal device, a mark processor for calculating the number of possible copies of the copy restriction mark to print on a copy of the output, and a controller for comparing the number of copies input by a user and the number of possible copies of the copy restriction mark formed on the output and determining whether to copy the output. Accordingly, the number of copies of the output can be restricted so that undesired copies, distributions, and so forth, can be prevented for a secure document, even when carelessly copied.

### CROSS-REFERENCE TO RELATED APPLICATIONS

This application claims the benefit under 35 U.S.C. §119(a) of Korean Patent Application No. 10-2005-0081745, filed Sep. 02, 2005 in the Korean Intellectual Property Office, the entire disclosure of which is incorporated herein by reference.

### BACKGROUND OF THE INVENTION

1. Field of the Invention

The present invention relates to an image forming apparatus and a copy restriction method thereof. More particularly, the present invention relates to an image forming apparatus for preventing a secure document from leaking and being distributed by restricting the number of copies, and a copy restriction method thereof.

2. Description of the Related Art

Recently, most companies use computers when performing their services and these computers are often on external networks as linked through a local area network (LAN) or wide area network (WAN). In doing so, secure documents or figures which ideally are to be used only inside the company can be burglarized, leaked and lost through such networks.

To prevent the above concerns, there are various measures which can be taken such as computer security, database security, network security and output document security.

For computer security, identification (ID) is confirmed to prevent data stored in the computer from leaking, copy authority for a floppy disk or CD writer is controlled, and data sharing with other computers through cables is restricted.

For database security, the knowledge management system (KMS) and the electronic document management system (EDMS) prevent an unauthorized user from accessing a secure document by authorizing writing or reading according to the document stored in the database.

For network security, a firewall is installed to control access of a hacker or a cracker, and thereby protect data. For security of output documents, locus of responsibility for the output data is written on the data so that secure data is protected and missing data is prevented.

For security of output documents, there are methods of using invisible ink, marking an original document and its copy to distinguish each, using radio frequency identification (RFID), and using a password.

One method of using invisible ink marks information including the outputting person, the company name and the date on the output. Accordingly, the person who has initially output the information and the outputting date can be identified. However, when the output is copied and distributed by people other than the initial person, the distribution can not be effectively prevented.

Another method of marking and automatically distinguishing an original document and its copy generates a particular mark upon copying or forging to visually identify the documents, or inputs information on a material which is capable of being seen through a special film. By using such methods, the original and its copy can be distinguished, but such methods can not prevent documents from being distributed.

The method of using an RFID typically serves to stick the RFID to a document to trace the document. However, the method can only trace the document. If the document is copied and distributed, it is impossible to trace the document copies.

In the method of using a password, a user personally inputs an ID and the corresponding password upon outputting a document so that only an authenticated user can copy documents. However, after outputting a document, the copying and distributing of the document can not be prevented.

Therefore, such conventional security methods of outputting documents can not practically be applied to leaks occurring through the copying and scanning of output documents. That is, when a user or a system copies or prints a secure file to an authenticated user, the information of the secure file can then be easily exposed to unauthenticated users.

Accordingly, a need exists for a system and method of substantially preventing a secure document from being distributed not only upon outputting the secure document, but also upon copying the secure document.

### SUMMARY OF THE INVENTION

An aspect of embodiments of the present invention is to substantially solve at least the above problems and/or disadvantages and to provide at least the advantages described below. Accordingly, an aspect of embodiments of the present invention is to provide an image forming apparatus for preventing a secure document from leaking and being distributed by restricting the number of copies, and a copy restriction method thereof.

In order to achieve the above-described and other aspects of embodiments of the present invention, an image forming apparatus is provided comprising a reader for receiving an output with a copy restriction mark including the number of possible copies, a printing part for printing the output which is input through the reader or provided from a user terminal device, a mark processor for calculating the number of possible copies of the copy restriction mark to print on a copy of the output, and a controller for comparing the number of copies input by a user and the number of possible copies of the copy restriction mark formed on the output and determining whether to copy the output.

The reader may comprise a visible reader for receiving visible data of the output to copy, and an invisible reader for receiving the copy restriction mark which is invisible data of the output to copy.

The printing part may comprise a visible printing part for printing visible print data which is input through the visible reader or provided from the user terminal device, and an invisible printing part for printing the copy restriction mark which is input through the invisible reader or provided from the user terminal device.

The controller can operate the mark processor to calculate the number of possible copies of the copies if the number of copies selected by the user is equal to or less than the number of possible copies of the output.

The mark processor can calculate the number of copies to print on the copies by subtracting the number of copies selected by the user from the number of possible copies of the output to print.

The mark processor can divide the value, obtained by subtracting the number of copies selected by the user from the number of possible copies of the output, by the number of the copy and set the result as the number of possible copies of each copy if the number of the copies is greater than one.

The mark processor can set the value, obtained by subtracting the number of copies selected by the user from the number of possible copies of the output, as the number of possible copies of one of the copy and set the number of possible copies of the remaining copies as 0, if the number of the copies is greater than one.

When the number of possible copies of the copy restriction mark is equal to or greater that the number of copies input by the user, if the user wants to block later copies, the controller can set the number of possible copies of the copy as 0.

When the number of possible copies of the copy restriction mark is less than the number of copies input by the user, the controller can inform the user that the copy is not allowed.

In order to achieve the above-described and other aspects of embodiments of the present invention, a copy restriction method of an image forming apparatus is also provided comprising the steps of selecting to copy an output with a copy restriction mark including the number of possible copies, comparing the number of possible copies and the number of copies input by a user, and calculating the number of possible copies to print on copies of the output and outputting the copies, or blocking the printing of the copies according to the compared result.

### BRIEF DESCRIPTION OF THE DRAWING FIGURES

The above and other aspects and features of embodiments of the present invention will become more apparent by describing in detail exemplary embodiments thereof with reference to the attached drawing figures, wherein;

FIG. 1 is a block diagram of an image input/output device according to embodiments of the present invention;

FIG. 2 is a view of an example of an output and copy with a copy restriction mark according to a first embodiment of the present invention;

FIG. 3 is a view of an example of an output and copy with a copy restriction mark according to the first embodiment of the present invention;

FIG. 4 is a view of an example of an output and copy with a copy restriction mark according to the first embodiment of the present invention; and

FIG. 5 is a flow chart illustrating an exemplary process of copy restriction in an image input/output device according to embodiments of the present invention.

Throughout the drawings, like reference numerals will be understood to refer to like parts, components and structures.

### DETAILED DESCRIPTION OF THE EXEMPLARY EMBODIMENTS

Hereinafter, exemplary embodiments of the present invention will be described in detail with reference to the accompanying drawing figures.

In the following description, same drawing reference numerals are used for the same elements even in different drawings. The matters defined in the description, such as detailed constructions and elements, are provided to assist in a comprehensive understanding of the invention. Also, well-known functions or constructions are not described in detail since they would obscure the invention in unnecessary detail.

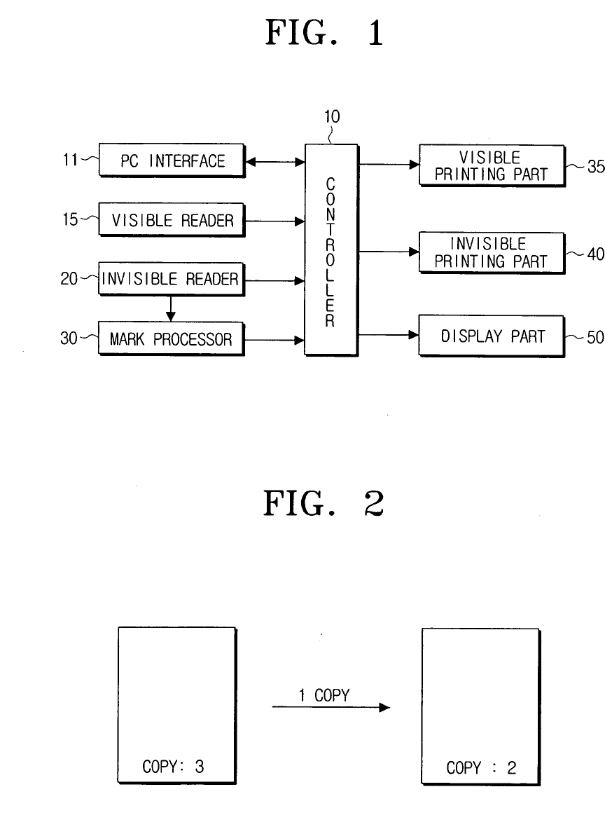

FIG. 1 is a block diagram of an image input/output device according to embodiments of the present invention. As shown in FIG. 1, the image input/output device reads information and provides an output. The image input/output device comprises a personal computer (PC) interface 11, a visible printing part 35, an invisible printing part 40, a visible reader 15, an invisible reader 20, a mark processor 30, a display part 50, and a controller 10.

The PC interface 11 receives print data from a user terminal device by communicating with the user terminal device and transmits the print data to an image processor. The image processor converts analog image data into a digital image format.

The visible printing part 35 comprises a plurality of components formed in a printer to print the print data provided from the user terminal device and data input through the visible reader 15.

The invisible printing part 40 comprises a plurality of components to print a copy restriction mark on the output using an invisible ink. The copy restriction mark is a mark which represents the number of printable copies of an output and represents the number as ‘COPY: 3’, for example. The copy restriction mark can comprise a security level of the output, information on an outputting person or printing person, the output date or print date and a secret number of the output. The security level of the output is preferably a standard to distinguish an outputting person who can access the output and can be distinguished through a plurality of steps according to the user preference. The information on an outputting person can preferably comprise an ID of an outputting person, name, place and position.

The invisible ink provided to print the copy restriction mark can preferably comprise ink that is invisible in a general visible area and which reacts to ultraviolet or black light for example. That is, the invisible ink is transparent in the visible area and appears red, green or blue by exposure to ultraviolet or black light. In the case of invisible ink reacting to ultraviolet light for example, its luminance is high in the long wavelength (365 nm) and short wavelength (254 nm), and if ultraviolet light is flashed on the pigment, atoms or molecules turn from excitation to baseband and energy corresponding to the difference between the two radiates as light so that it becomes visible.

The visible printing part 35 and the invisible printing part 40 can share components or can be constructed with different components, respectively. Considering the size of a printer and manufacturing costs, it is preferable to use general purpose ink and invisible ink one after the other to print a print image and a copy restriction mark by sharing the components and equipping the shared components with the general ink and invisible ink.

The visible reader 15 comprises a light source to flash an object to scan, and a charge-coupled device (CCD) to convert light reflected from the object into an electric signal and form an image. The visible reader 15 reads the words and images printed in the general ink on the scanned document.

The invisible reader 20 comprises ultraviolet or black light to flash at an object to scan, and a CCD to receive red, green or blue light reflected from the object and form an image. Accordingly, the invisible reader 20 can read words or images printed in the invisible ink, and the invisible reader 20 of the scanner according to embodiments of the present invention reads the copy restriction mark printed in the invisible ink on the document.

The mark processor 30 determines whether to print the copy restriction mark to be printed on the output, and calculates the number of possible copies to be printed on the copies according to the information on the copy restriction mark provided from the invisible reader 20. When the output is not copied but printed, the mark processor 30 determines whether to print the copy restriction mark based on the information input from the user terminal device or an input panel of the printer. For example, when a user previously wrote and stored a document in the database with a security level set up and wants to print the document later, the mark processor 30 determines that the document has to be printed with the copy restriction mark according to the information on the security level included in the print data. The number of possible copies to be printed as the copy restriction mark is stored together in the database. Meanwhile, when a user writes a document and directly prints the document, the user transmits a secure print command to print a secure document and the secure print command can be set through the print window of the application with which the user writes the document. If the user selects the secure print command through the print window, the mark processor 30 determines that the document is the secure document and provides the information to print the copy restriction mark to the controller 10. At this moment, the user can select the number of possible copies to be included in the copy restriction mark through the print window.

The mark processor 30 updates the number of possible copies included in the copy restriction mark upon copying the output. For example, as shown in FIG. 2, if the number of possible copies of the output of the object to copy is 3, that is, ‘COPY: 3’ is displayed, and the number of copies to newly copy is 1, the mark processor 30 provides the information to the controller 10 to print that the number of possible copies is 2 for the copy restriction mark of the copy, that is, ‘COPY: 2’.

When ‘COPY: 3’ is written in the copy restriction mark of the output of an object to copy and the number of copies to newly copy is 2, if the copy restriction mark is printed as ‘COPY: 1’ in two copies, respectively, two outputs respectively can generate a new copy. As the result, four copies are output.

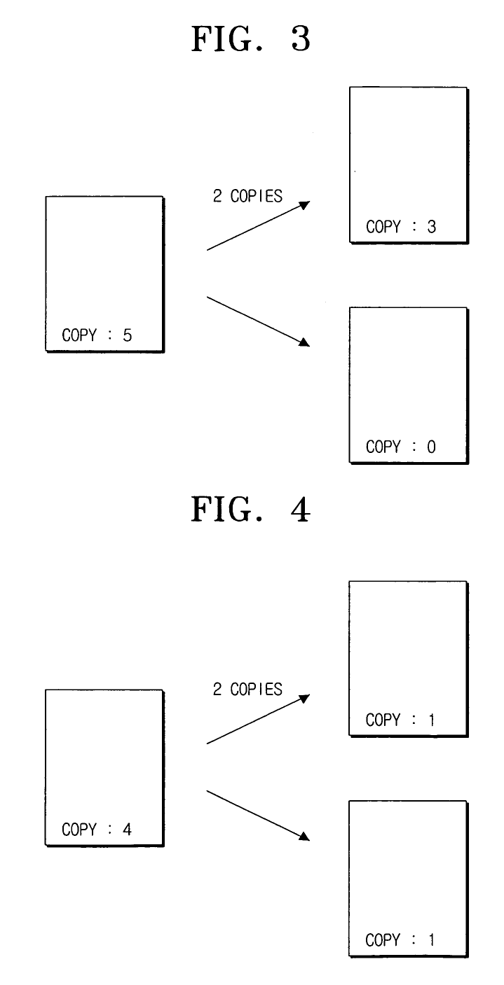

To prevent this, when two or more outputs are output at a time, the mark processor 30 sets the copy restriction mark with the number of the remaining possible copies to be printed on only one of the outputs and sets other outputs not to be printed, that is, to be printed with ‘COPY: 0’ as the copy restriction mark not to recopy other outputs. For example, as shown in FIG. 3, if the number of possible copies of the output of the object to copy is 5 and the number of copies are 2, one of the copies is set to be printed with the copy restriction mark of ‘COPY: 3’ and the other copy is set to be printed with the copy restriction mark of ‘COPY: 0’.

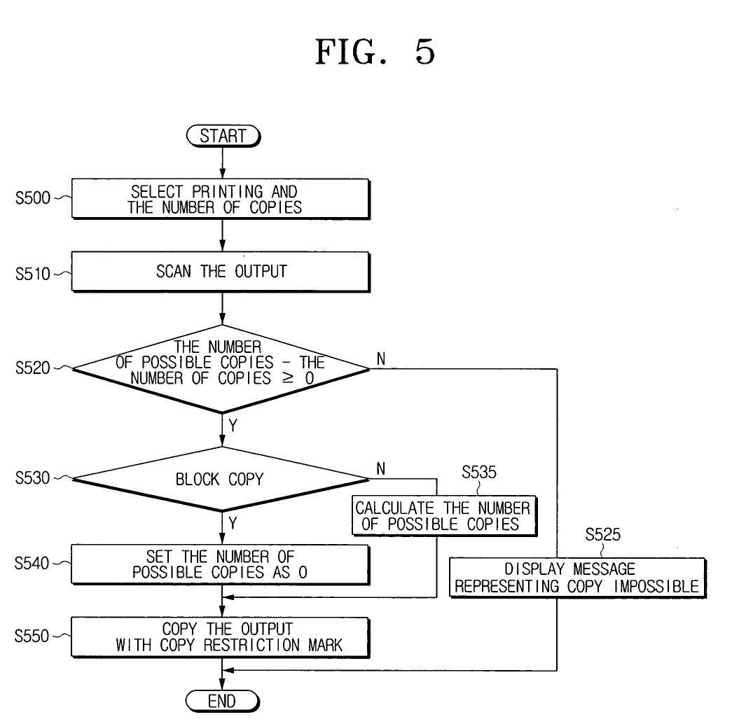

In yet another method implemented according to an embodiment of the present invention, the mark processor 30 can be set to distribute and write the number of possible copies on the copies. For example, as shown in FIG. 4, if the number of possible copies of the output of the object to copy is 4 and the number of copies are 2, the two copies respectively can be set to be printed with ‘COPY: 1’.

The display part 50 displays what a user selects or an information message to communicate with the user.

The controller 10 operates the visible printing part 35 and the invisible printing part 40 to print copies with the number of possible copies calculated in the mark processor 30 for outputs with the copy restriction mark provided from the visible reader 15 and the invisible reader 20.

If the number of possible copies of the copy restriction mark read by the invisible reader 20 is 0, the controller 10 displays a message through the display part 50 that a copy is not allowed. Additionally, if a copy of the output of the object to copy is possible, the controller 10 can process the number of the remaining possible copies as 0 according to the user preference. For example, even when the number of possible copies is 1 or more, the controller 10 controls a message display that asks whether a user desires to block the copy of the corresponding output through the display part 50. If the user wants to block the copy, the controller 10 controls the invisible printing part 40 to print the number of possible copies as 0.

Referring to FIG. 5, an exemplary process of restricting the copy of an output in the image output device with the above construction is illustrated, and comprises the following steps as follows.

First, when initially printing an output, if print data is input through the PC interface 11, the controller 10 operates the mark processor 30 to determine whether to print the copy restriction mark according to the security level of the output. If the copy restriction mark is to be printed on the output, the controller 10 operates the visible printing part 35 and the invisible printing part 40 to print visible print data and the copy restriction mark including the number of possible copies set by the mark processor 30.

When a user wants to copy the output with the copy restriction mark, the user selects the number of copies and presses the copy button at step (S500). The controller 10 operates the visible reader 15 and the invisible reader 20 to scan the output at step (S510). When the invisible reader 20 senses the copy restriction mark, the controller 10 compares the number of possible copies provided from the invisible reader 20 and the number of copies input by the user at step (S520). As the result, if the number of possible copies is less than the desired number of copies, the controller 10 displays the message representing that a copy is not allowed through the display part 50 at step (S525).

If the number of possible copies is equal to or greater than the number of desired copies, the controller 10 displays the message asking whether to block any copy after copying the output through the display part 50 at step (S530). If the user selects ‘YES’, the controller 10 controls the invisible printing part 40 to print the copy restriction mark as ‘COPY: 0’ at step (S540).

However, if the user selects ‘NO’, the controller 10 operates the mark processor 30 to set the number of possible copies of the copy restriction mark to be printed on each output at step (S535). As shown in FIG. 2, if the number of possible copies of the output of the object to copy is 3, that is, ‘COPY: 3’ is displayed, and the number of copies to newly copy is 1, the mark processor 30 provides the information to the controller 10 to print that the number of possible copies is 2 for the copy restriction mark of the copy, that is, ‘COPY: 2’.

Subsequently, the controller 10 operates the visible printing part 35 and the invisible printing part 40 to print the visible print data and the corresponding copy restriction mark at step (S550).

The image forming apparatus according to embodiments of the present invention prints the copy restriction mark on the output using invisible ink and decreases the number of possible copies marked on the copy restriction mark upon every copy so that the number of copies of the output is limited to the preset number of possible copies. Accordingly, the number of possible copies is limited for a secure document, so that the secure document can be prevented from being indiscreetly copied and distributed.

In yet other embodiments of the present invention, the copy restriction mark can be printed not only in invisible ink as shown in the above exemplary embodiments, but can also be printed in visible ink.

As can be appreciated from the above description, the number of copies of the output is restricted so that undesired copies, distributions, and so forth, can be prevented for a secure document, even when carelessly copied.

While the present invention has been shown and described with reference to certain exemplary embodiments thereof, it will be understood by those skilled in the art that various changes in form and details may be made therein without departing from the spirit and scope of the invention as defined by the appended claims.

What is claimed is:

1. An image forming apparatus, comprising:
a reader for receiving an output with a copy restriction mark including the number of possible copies;
a printing part for printing the output which is input through the reader or provided from a user terminal device;
a mark processor for calculating the number of possible copies of the copy restriction mark to print on a copy of the output; and
a controller for comparing the number of copies input by a user and the number of possible copies of the copy restriction mark formed on the output, and determining whether to copy the output.

2. The image forming apparatus of claim 1, wherein the reader comprises:
a visible reader for receiving visible data of the output to copy; and
an invisible reader for receiving the copy restriction mark which is invisible data of the output to copy.

3. The image forming apparatus of claim 1, wherein the printing part comprises:
a visible printing part for printing visible print data which is input through the visible reader or provided from the user terminal device; and
an invisible printing part for printing the copy restriction mark which is input through the invisible reader or provided from the user terminal device.

4. The image forming apparatus of claim 1, wherein the controller is configured to operate the mark processor to calculate the number of possible copies of the copies, if the number of copies selected by the user is equal to or less than the number of possible copies of the output.

5. The image forming apparatus of claim 4, wherein the mark processor is configured to calculate the number of copies to print on the copies by subtracting the number of copies selected by the user from the number of possible copies of the output to print.

6. The image forming apparatus of claim 5, wherein the mark processor is configured to divide the value, obtained by subtracting the number of copies selected by the user from the number of possible copies of the output, by the number of the copies and set the result as the number of possible copies of each copy, if the number of the copies is greater than one.

7. The image forming apparatus of claim 5, wherein the mark processor is configured to set the value obtained by subtracting the number of copies selected by the user from the number of possible copies of the output, as the number of possible copies of one of the copies and set the number of possible copies of the remaining copies as 0, if the number of the copies is greater than one.

8. The image forming apparatus of claim 1, wherein when the number of possible copies of the copy restriction mark is equal to or greater than the number of copies input by the user, if the user wants to block later copies, the controller is configured to set the number of possible copies of the copy as 0.

9. The image forming apparatus of claim 1, wherein when the number of possible copies of the copy restriction mark is less than the number of copies input by the user, the controller is configured to inform the user that the copy is not allowed.

10. A copy restriction method of an image forming apparatus, comprising:
selecting to copy an output with a copy restriction mark including the number of possible copies;
comparing the number of possible copies and the number of copies input by a user; and
calculating the number of possible copies to print on copies of the output and outputting the copies, or blocking the printing of copies according to the compared result.

11. The method of claim 10, further comprising forming the copy restriction mark with invisible ink.

12. The method of claim 10, wherein as the result of comparing the number of possible copies and the number of copies input by the user, when the number of copies is equal to or less than the number of possible copies, the number of possible copies of the copies is calculated.

13. The method of claim 12, wherein when the number of possible copies of the copies is calculated, the mark processor calculates the number of copies to print on the copies by subtracting the number of copies selected by the user from the number of possible copies of the output.

14. The method of claim 13, wherein the value obtained by subtracting the number of copies selected by the user from the number of possible copies of the output, is divided by the number of the copies and is set as the number of possible copies of each copy, if the number of the copies is greater than one.

15. The method of claim 13, wherein the value obtained by subtracting the number of copies selected by the user from the number of possible copies of the output, is set as the number of possible copies of one of the copies and the number of possible copies of the remaining copies is set as 0, if the number of the copies is greater than one.

16. The method of claim 10, further comprising:
if the number of possible copies of the copy restriction mark is greater than the number of copies input by the user, asking the user whether to block copies of the output after the copy; and
when the user wants to block copies of the output, the number of possible copies of the copy is set as 0.

17. The method of claim 10, further comprising:
if the number of possible copies of the copy restriction mark is less than the number of copies input by the user, informing the user that the copy is not allowed.
